(19) United States
(12) Patent Application Publication
(10) Pub. No.: US 2013/0016971 A1
(43) Pub. Date: Jan. 17, 2013

(54) WDM OPTICAL SYSTEM AND METHOD INCLUDING MULTI-CHANNEL TRANSMITTERS WITH FILTERED OUTPUT FOR CHANNEL WAVELENGTH SELECTION

(71) Applicants: Jun Zheng, Missouri City, TX (US); Stefan J. Murry, Houston, TX (US)

(72) Inventors: Jun Zheng, Missouri City, TX (US); Stefan J. Murry, Houston, TX (US)

(73) Assignee: APPLIED OPTOELECTRONICS, INC., Sugar Land, TX (US)

(21) Appl. No.: 13/543,310

(22) Filed: Jul. 6, 2012

Related U.S. Application Data
(60) Provisional application No. 61/508,008, filed on Jul. 14, 2011.
(60) Provisional application No. 61/508,011, filed on Jul. 14, 2011.

(51) Int. Cl. H04B 10/20; H04J 14/02

(52) U.S. Cl. 398/58; 398/89

(57) ABSTRACT

A wavelength division multiplexed (WDM) optical system generally includes multi-channel transmitters that transmit optical signals on multiple channel wavelengths in the WDM system. The output of the multi-channel transmitters is filtered to select a unique channel wavelength associated with each of the respective transmitters for multiplexing and transmission in the WDM optical system. One embodiment of a multi-channel transmitter includes a full-spectrum Fabry-Perot (FP) laser that emits light across a range of wavelengths including all of the system channel wavelengths. Another embodiment of a multi-channel transmitter includes a broadly-tunable FP laser that is tunable to emit light across different ranges of wavelengths including subsets of the system channel wavelengths. The WDM optical system may include an arrayed waveguide grating (AWG) for filtering and multiplexing the optical signals output from the transmitters.

### CROSS-REFERENCE TO RELATED APPLICATIONS

The present application claims the benefit of U.S. Provisional Patent Application Ser. No. 61/508,008 filed on Jul. 14, 2011 (Attorney Docket No. PAT144P) and U.S. Provisional Patent Application Ser. No. 61/508,011 filed on Jul. 14, 2011 (Attorney Docket No. PAT145P), which are fully incorporated herein by reference.

### TECHNICAL FIELD

The present invention relates to wavelength division multiplexed (WDM) optical systems, networks, and methods and more particularly, to a WDM optical system including multi-channel transmitters with filtered output for channel wavelength selection.

### BACKGROUND INFORMATION

Optical communications networks have been deployed for many years. Originally, these networks were generally “point to point” type networks including a transmitter and a receiver connected by an optical fiber. Such networks are relatively easy to construct but deploy many fibers to connect multiple users. As the number of subscribers connected to the network increases, the fiber count also increases rapidly and the expense of deploying and managing many fibers becomes complex and expensive.

A passive optical network (PON) addresses this problem by using a single “trunk” fiber from a transmitting end of the network, such as an optical line terminal (OLT), to a remote branching point, which may be up to 20 km or more. Each subscriber may be connected to the network utilizing a much shorter fiber span forming an architecture sometimes referred to as “tree and branch.” One challenge in developing such a PON is utilizing the capacity in the trunk fiber efficiently in order to transmit the maximum possible amount of information on the trunk fiber.

To improve efficiency, PONs have used “time domain multiplexing” by assigning each subscriber on the PON a particular time slot for transmission of its data along the trunk fiber. Each subscriber is allowed to transmit during its assigned time slot, and these slots are synchronized at both the transmitter and receiver such that the receiver knows the time slot (and thus the transmitter) of a transmitted signal. In this way, many transmitters can share the same fiber without fear of multiple transmitters sending data at the same time and confusing the receiver. Standards such as gigabit PON (G-PON) and Ethernet-based PON (E-PON), for example, utilize this time-dependant approach.

Although TDM-PON systems work, the TDM approach is inefficient because the system should allow sufficient time between different transmitter time slots to prevent confusion at the receiving end. Also, noise in this type of system is cumulative across all the transmitters in the PON. To avoid unwanted noise, transmitters other than the one currently transmitting may be turned off and then turned on rapidly when it is time to transmit data, without providing much stabilization time. This “burst mode” transmission makes it challenging to increase data rates in a TDM-PON system.

TDM also does not make efficient use of the bandwidth available on the fiber. Optical fiber has the ability to carry many different signals simultaneously, without interfering, as long as these different signals are carried on different wavelengths. TDM-PON systems utilize only a few wavelengths and therefore do not utilize much of the fundamental bandwidth available on the optical fiber. Similar to radio transmissions utilizing different frequencies to carry different signals, fiber optic communications networks may increase the amount of information carried on a single optical fiber by multiplexing different optical signals on different wavelengths using wavelength division multiplexing (WDM).

In a WDM-PON, a single trunk fiber carries data to and from an optical branching point and the branching point provides a simple routing function by directing signals of different wavelengths to and from individual subscribers. In this case, each subscriber is assigned a particular wavelength on which to send and/or receive data. The WDM-PON thus allows much greater bandwidth because each transmitter is allowed to transmit at a higher data rate and for a longer period of time.

A challenge in a WDM-PON, however, is designing a network that will allow the same transmitter to be used in an optical networking terminal (ONT) at any subscriber location. For ease of deployment and maintenance in a WDM-PON, it is desirable to have a “colorless” ONT whose wavelength can be changed or tuned such that a single device could be used in any ONT on the PON. With a “colorless” ONT, an operator only needs to have a single, universal transmitter or transceiver device that can be employed at any subscriber location.

One or more tunable laser sources may be used to provide multiple optical signals at different wavelengths in a WDM system or network such as a WDM-PON. Similar to a tuner section of a radio transmitter allowing the transmitter to select the frequency on which to transmit, a tunable laser has the capability to select different wavelengths on which to transmit optical signals. Various different types of tunable lasers have been developed over the years, but most of these were developed for high-capacity backbone connections to achieve high performance and at a relatively high cost. Many tunable laser sources rely on continuous tuning mechanisms and may be difficult and expensive to construct because of extremely tight manufacturing tolerances. Many continuously tunable lasers also require an external means to “lock” the wavelength similar to a phase-locked loop or crystal reference oscillator in a radio tuner. These wavelength lockers are used because the continuously tunable designs are often highly sensitive to external conditions that can cause the wavelength to drift if not corrected. Conditions such as temperature or external electrical or magnetic fields, for example, can cause drift in some continuously-tunable laser designs.

Many WDM-PON applications have lower data rates and shorter transmission distances as compared to high-capacity, long-haul WDM systems, and thus a lower performance and lower cost laser may suffice. Also, continuous tuning may not be necessary in WDM-PON applications, although the ability to select a wavelength from among several wavelengths (e.g., in a grid of channel wavelengths) is desirable. In some of these applications, the wavelength may be selected only once in the lifetime of the laser (i.e., when it is initially installed) and this wavelength may not need to be changed again.

### BRIEF DESCRIPTION OF THE DRAWINGS

These and other features and advantages will be better understood by reading the following detailed description, taken together with the drawings wherein:

FIG. 1 is a diagrammatic view of a wavelength division multiplexed (WDM) optical communication system including multi-channel transmitters with filtered output to provide wavelength selection, consistent with an embodiment.

FIG. 2 is a diagrammatic view of a WDM passive optical network (PON) including multi-channel transmitters with filtered output to provide channel wavelength selection, consistent with an embodiment.

FIG. 3 is a schematic diagram of a WDM optical system including multi-channel transmitters with full-spectrum Fabry-Perot lasers, consistent with an embodiment.

FIG. 4 is a schematic diagram of a WDM optical system including multi-channel transmitters with broadly-tunable Fabry-Perot lasers, consistent with another embodiment.

FIG. 5 is a schematic diagram of a WDM optical system including FP lasers coupled to an arrayed waveguide grating (AWG), consistent with a further embodiment.

FIG. 6 illustrates transmitted channel bands or passbands of an arrayed waveguide grading (AWG) that may be used to filter output of the transmitter to a selected channel wavelength.

FIG. 7 illustrates laser output power as a function of wavelength for a regular Fabry-Perot laser together with the AWG transmitted channel bands.

FIG. 8 illustrates laser output power as a function of wavelength for a narrow mode spacing Fabry-Perot laser together with the AWG transmitted channel bands and before the AWG.

FIG. 9 illustrates laser output power as a function of wavelength for a narrow mode spacing Fabry-Perot laser after being filtered by the AWG to select a channel wavelength.

FIG. 10 illustrates laser output power as a function of wavelength for a full spectrum Fabry-Perot laser together with the AWG transmitted channel bands.

FIG. 11 illustrates laser output power as a function of wavelength for a full spectrum Fabry-Perot laser after being filtered to select a channel wavelength associated with one channel.

FIG. 12 illustrates laser output power as a function of wavelength for a full spectrum Fabry-Perot laser after being filtered to select a channel wavelength associated with another channel.

FIG. 13 illustrates laser output power as a function of wavelength for a broadly-tunable Fabry-Perot laser with a spectrum shifted by tuning and together with the AWG transmitted channel bands.

FIG. 14 illustrates laser output power as a function of wavelength for a broadly-tunable narrow mode spacing Fabry-Perot laser after being tuned and filtered to select a channel wavelength.

### DETAILED DESCRIPTION

A wavelength division multiplexed (WDM) optical system, consistent with embodiments described herein, generally includes multi-channel transmitters that transmit optical signals on multiple channel wavelengths in the WDM system. The output of the multi-channel transmitters is filtered to select a unique channel wavelength associated with each of the respective transmitters for multiplexing and transmission in the WDM optical system. One embodiment of a multi-channel transmitter includes a full-spectrum Fabry-Perot (FP) laser that emits light across a range of wavelengths including all of the system channel wavelengths. Another embodiment of a multi-channel transmitter includes a broadly-tunable FP laser that is tunable to emit light across different ranges of wavelengths including subsets of the system channel wavelengths. The WDM optical system may include an arrayed waveguide grating (AWG) for filtering and multiplexing the optical signals output from the transmitters.

In one application, the WDM optical system may include a WDM passive optical network (PON) and the multi-channel transmitters may be used in one or more optical networking terminals (ONT) or optical networking units (ONU) and/or in an optical line terminal (OLT). Because the multi-channel transmitters are capable of transmitting more than one unique channel wavelength, the multi-channel transmitters are designed to be universal and may be interchangeable with other multi-channel transmitters in the WDM PON.

As used herein, “channel wavelengths” refer to the wavelengths associated with optical channels and may include a specified wavelength band around a center wavelength. In one example, the channel wavelengths may be defined by an International Telecommunication (ITU) standard such as the ITU-T dense wavelength division multiplexing (DWDM) grid. As used herein, “interchangeable” refers to transmitters that are not limited to transmitting at a particular channel wavelength and may be used in multiple different nodes or terminals of a WDM optical system such as a WDM passive optical network (PON) without having to be substantially reconfigured. Interchangeable transmitters may be, but are not necessarily, identical. The term “coupled” as used herein refers to any connection, coupling, link or the like by which signals carried by one system element are imparted to the “coupled” element and “optically coupled” refers to coupling such that light from one element is imparted to another element. Such “coupled” devices are not necessarily directly connected to one another and may be separated by intermediate components or devices that manipulate or modify such signals.

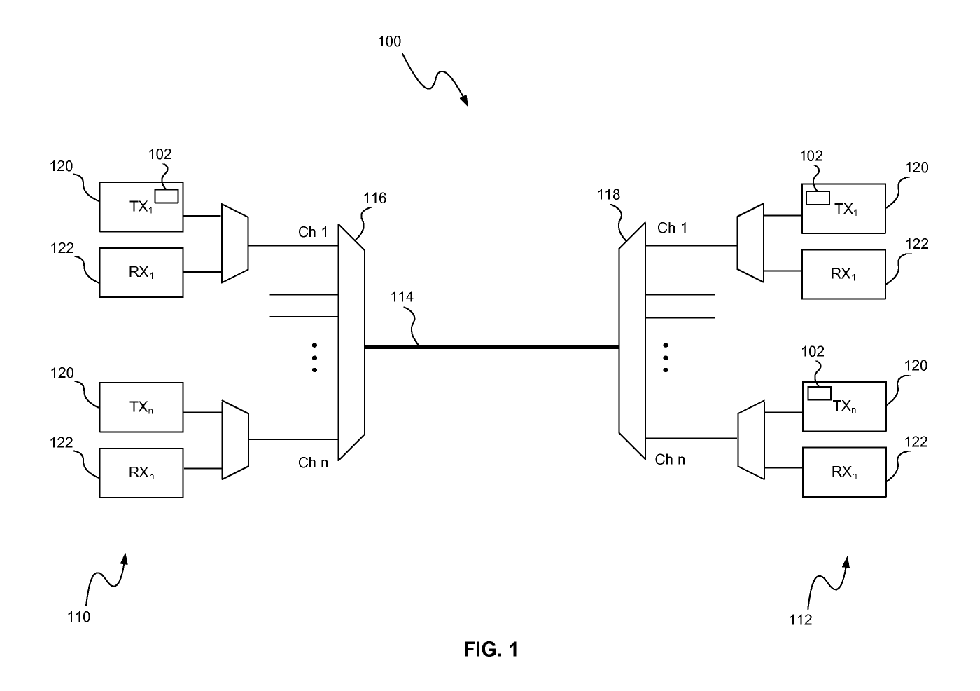

Referring to FIG. 1, a WDM optical communication system 100 including multi-channel transmitters with a filtered output for channel wavelength selection, consistent with embodiments of the present disclosure, is shown and described. The WDM system 100 includes one or more terminals 110, 112 coupled at each end of a trunk optical fiber or path 114 for transmitting and receiving optical signals at different channel wavelengths over the trunk optical path 114. The terminals 110, 112 at each end of the WDM system 100 include one or more transmitters 120 (e.g., TX₁ to TXₙ) and receivers 122 (e.g., RX₁ to RXₙ) associated with different channels (e.g., Ch. 1 to Ch. n) for transmitting and receiving optical signals between the one or more terminals 110, 112. Each terminal 110, 112 may include one or more transmitters 120 and receivers 122, and the transmitters 120 and receivers 122 may be separate or integrated as a transceiver within a terminal.

Although each of the transmitters 120 is associated with different respective channels and channel wavelengths, one or more of the transmitters 120 may be multi-channel transmitters configured to transmit optical signals at a plurality of channel wavelengths (e.g., a subset of the system channel wavelengths or all of the system channel wavelengths) instead of transmitting at only the associated channel wavelength. The multi-channel transmitters 120 may include FP lasers 102, such as standard diode lasers, capable of emitting light across a range of wavelengths including at least a subset of the system channel wavelengths (e.g., λ₁ to λₙ) used by the WDM system 100. The WDM system 100 filters the outputs from the multi-channel transmitters 120 to select the channel wavelengths associated with the respective transmitters for multiplexing and transmission on the trunk optical path 114.

Optical multiplexers/demultiplexers 116, 118 at each end of the WDM system 100 combine and separate the optical signals at the different channel wavelengths associated with the transmitters 120 and receivers 122. Aggregate WDM optical signals including the combined channel wavelengths are carried on the trunk optical path 114. The optical multiplexers 116, 118, for example, may include arrayed waveguide gratings (AWGs) that provide both filtering to select a different associated channel wavelength for each of the transmitters 120 and provide multiplexing to combine the selected associated channel wavelengths for transmission as a WDM signal over the optical path 114. Other types of filters may be used either in the optical multiplexers/demultiplexers 116, 118 or separately from the optical multiplexers/demultiplexers. By transmitting optical signals at multiple channel wavelengths and performing the wavelength selection separately from the multi-channel transmitters, the multi-channel transmitters are designed as universal transmitters capable of being used in different locations in the WDM system 100 and may be interchangeable with other multi-channel transmitters in the WDM system 100.

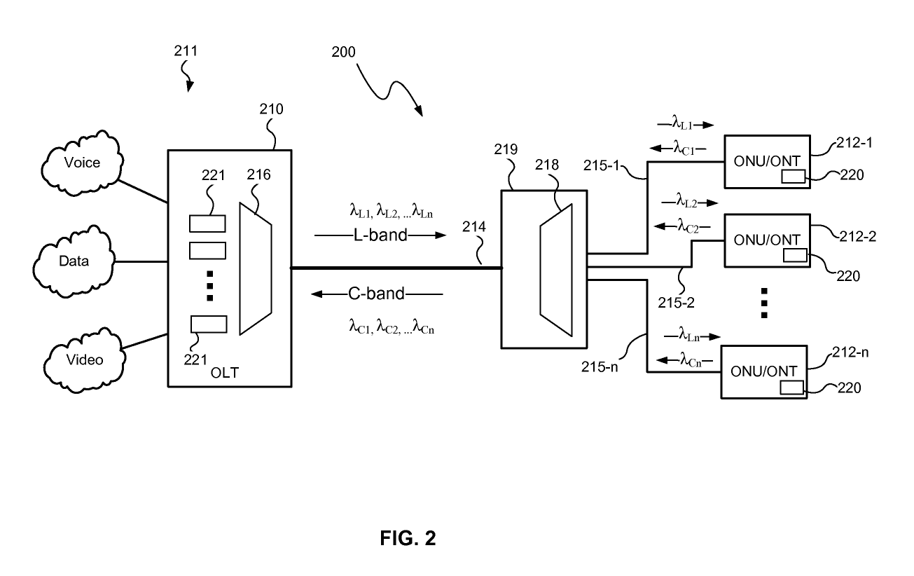

Referring to FIG. 2, one or more multi-channel transmitters, consistent with embodiments of the present disclosure, may be used in a WDM-PON 200. The WDM-PON 200 provides a point-to-multipoint optical network architecture using a WDM system. According to one embodiment of the WDM-PON 200, a central office (CO) 211 including one or more optical line terminals (OLTs) 210 may be coupled to a plurality of optical networking terminals (ONTs) or optical networking units (ONUs) 212-1 to 212-n via optical fibers, waveguides, and/or paths 214, 215-1 to 215-n. A branching point 219 couples the trunk optical path 214 to the separate optical paths 215-1 to 215-n to the ONUs/ONTs 212-1 to 212-n at the subscriber locations. The branching point 219 may include one or more passive coupling devices such as a splitter or optical multiplexer/demultiplexer. The ONUs/ONTs 212-1 to 212-n may be located in homes, businesses or other types of subscriber location or premises.

The WDM-PON 200 may also include additional nodes or network devices, such as Ethernet PON (EPON) or Gigabit PON (GPON) nodes or devices, coupled between the branching point 219 and ONUs/ONTs 212-1 to 212-n at different locations or premises. One application of the WDM-PON 200 is to provide fiber-to-the-home (FTTH) or fiber-to-the-premises (FTTP) capable of delivering voice, data, and/or video services across a common platform. In this application, the CO 211 may be coupled to one or more sources or networks providing the voice, data and/or video.

In the WDM-PON 200, different ONUs/ONTs 212-1 to 212-n may be assigned different channel wavelengths and optical signals may be transmitted on the different channel wavelengths and combined and separated using WDM techniques. One or more of the ONUs/ONTs 212-1 to 212-n may thus include a multi-channel transmitter 220 for generating an optical signal at multiple channel wavelengths and the branching point 219 may include an AWG 218 for selecting an associated one of the multiple channel wavelengths and for combining the selected associated channel wavelengths for transmission to the OLT 210. Thus, the same device in the WDM-PON node that provides wavelength routing may be used to provide the filtering and wavelength selection. The OLT 210 may also include one or more multi-channel transmitters 221 for generating optical signals at multiple channel wavelengths and an AWG 216 for selecting associated ones of the multiple channel wavelengths and for combining the selected associated channel wavelengths for transmission to the ONUs/ONTs 212-1 to 212-n.

In one embodiment, the WDM-PON 200 may use different wavelength bands for transmission of downstream and upstream optical signals relative to the OLT 210. For example, the L-band (e.g., about 1565 to 1625 nm) may be used for downstream transmissions and the C-band (e.g., about 1530 to 1565 nm) may be used for upstream transmissions. The ONUs/ONTs 212-1 to 212-n may thus be assigned different channel wavelengths within the L-band and within the C-band. Transmitters in the OLT 210 may be configured to transmit optical signals on multiple channel wavelengths in the L-band, and transceivers or receivers located within the ONUs/ONTs 212-1 to 212-n may be configured to receive an optical signal on at least one channel wavelength in the L-band. Transceivers or transmitters located within the ONUs/ONTs 212-1 to 212-n may be configured to transmit optical signals on multiple channel wavelengths within the C-band. Other wavelengths and wavelength bands are also within the scope of the system and method described herein.

In the example embodiment, the multi-channel transmitters 221 in the OLT 110 may generate optical signals at a subset of or all of the channel wavelengths in the L-band (e.g., λ_{L1}, λ_{L2}, . . . λ_{Ln}). Each of the FP lasers in the multi-channel transmitters 221 may be modulated by a respective RF signal to generate the respective optical signals, and the AWG 216 selects associated channel wavelengths (e.g., λ_{L1}, λ_{L2}, . . . λ_{Ln}) for each of the respective transmitters 221 and combines the optical signals at the different associated channel wavelengths. The branching point 219 may demultiplex the downstream aggregate WDM optical signal (e.g., λ_{L1}, λ_{L2}, . . . λ_{Ln}) from the OLT 210 for transmission of the separate channel wavelengths to the respective ONUs/ONTs 212-1 to 212-n. Alternatively, the branching point 219 may provide the aggregate WDM optical signal to each of the ONUs/ONTs 212-1 to 212-n and each of the ONUs/ONTs 212-1 to 212-n separates and processes the assigned optical channel wavelength. The individual optical signals may be encrypted to prevent eavesdropping on optical channels not assigned to a particular ONU/ONT.

In the example embodiment, the multi-channel transmitters 220 in one or more of the ONUs/ONTs 212-1 to 212-n may generate an optical signal at a subset of or all of the channel wavelengths in the C-band (e.g., λ_{C1}, λ_{C2}, . . . λ_{Cn}). Each of the FP lasers in the multi-channel transmitters 220 may be modulated by a respective RF signal to generate the optical signal, and the AWG 218 in the branching point 219 selects associated channel wavelengths (e.g., λ_{C1}, λ_{C2}, . . . λ_{Cn}) for each of the respective transmitters 220 and combines or multiplexes the upstream optical signals from the respective ONUs/ONTs 212-1 to 212-n for transmission as an aggregate WDM optical signal over the trunk optical path 214 to the OLT 210.

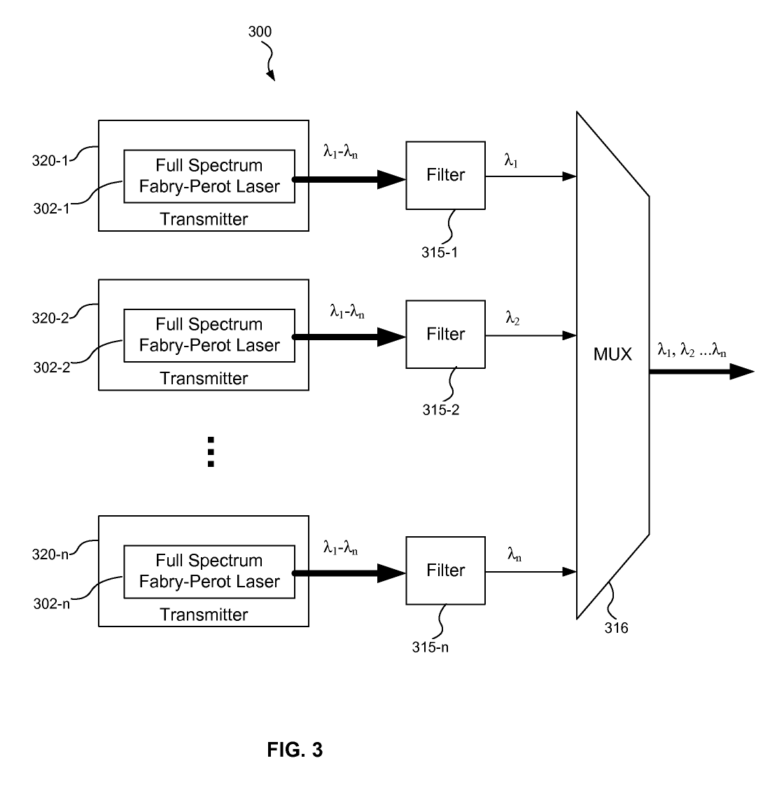

FIG. 3 shows one embodiment of a WDM optical system 300 including multi-channel transmitters 320-1 to 320-n with full-spectrum FP lasers 302-1 to 302-n. Each of the multi-channel transmitters 320-1 to 320-n is associated with one of the channel wavelengths λ₁, λ₂, . . . λₙ). The full-spectrum FP lasers 302-1 to 302-n are capable of lasing across a full spectrum of wavelengths covering at least the system channel wavelengths (e.g., λ₁ to λₙ) of the WDM system (e.g., the L-band, the C-band, or both). In this embodiment, each of the multi-channel transmitters 320-1 to 320-n transmit optical signals across the full spectrum of channel wavelengths (e.g., λ₁ to λₙ) and the associated channel wavelengths for each of the transmitters 320-1 to 320-n are selected later for multiplexing and transmission.

The WDM optical system 300 includes filters 315-1 to 315-n to select the channel wavelengths associated with each of the respective transmitters and a multiplexer 316 to combine the selected channel wavelengths. In other words, the filters 315-1 to 315-n reject the wavelengths outside of the relatively narrow range around the selected channel wavelengths associated with the respective transmitters 320-1 to 320-n. For example, the filter 315-1 selects a first channel wavelength (λ₁) from the full spectrum of channel wavelengths (λ₁ to λₙ) transmitted by the multi-channel transmitter 320-1 associated with a first channel, the filter 315-2 selects a second channel wavelength (λ₂) from the full spectrum of channel wavelengths (λ₁ to λₙ) transmitted by the multi-channel transmitter 320-2 associated with a second channel, and so forth. In one example, the full spectrum of wavelengths may cover 32 channel wavelengths (λ₁ to λ₃₂) of a WDM-PON system.

Using full spectrum Fabry-Perot lasers in the multi-channel transmitters allows the transmitters (e.g., in the ONT/ONUs of a WDM-PON) to be interchangeable and avoids using tunable lasers. Designing a laser to accommodate the wide range required by the network (e.g., 40 nm or more) would result in a laser with a broad and relatively flat gain peak. Using this laser alone (i.e. without further means of limiting the wavelength of transmission) would result in a signal with many different modes and the noise generated by competition between these modes (e.g., caused by mode-hopping or mode partition noise, or other sources) would limit the transmission distance and/or datarate achievable. By limiting the range of possible wavelengths transmitted (e.g., using the filters), the disclosed optical network allows greater transmission distance and/or higher datarates than would be possible using only an FP laser with a broad wavelength emission spectrum.

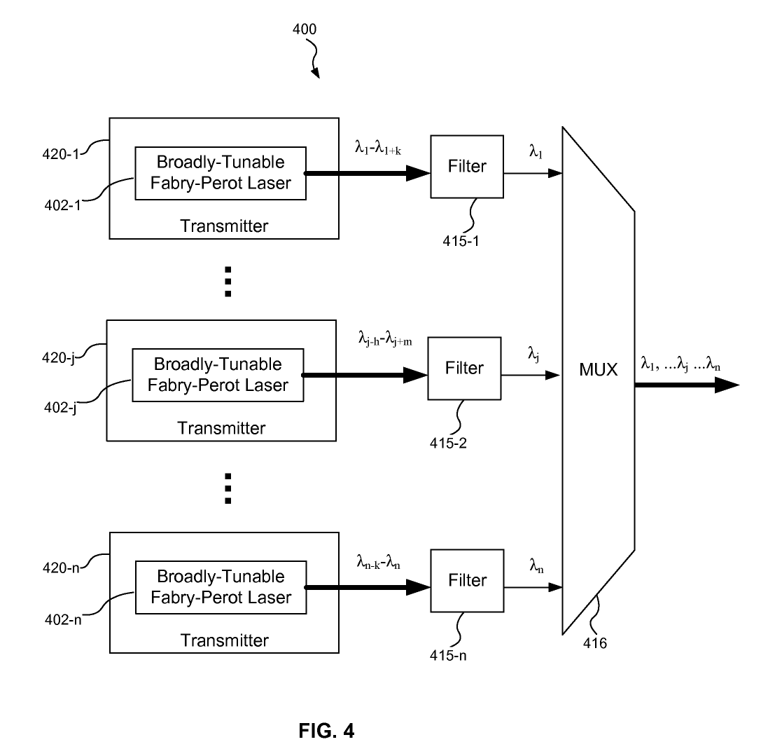

FIG. 4 shows an embodiment of a WDM optical system 400 including multi-channel transmitters 420-1 to 420-n with coarsely or broadly-tunable FP lasers 402-1 to 402-n. Each of the multi-channel transmitters 420-1 to 420-n is associated with one of the channel wavelengths (λ₁, . . . λⱼ, . . . λₙ). Each of the broadly-tunable FP lasers 402-1 to 402-n in the transmitters 420-1 to 420-n is capable of being tuned to lase across a selected subset of wavelengths within a broader spectrum of wavelengths. The broadly-tunable FP lasers 402-1 to 402-n may be tuned, for example, by changing the temperature (or by other means) and shifting the spectrum of the laser.

Each of the broadly-tunable FP lasers 402-1 to 402-n is capable of being tuned to emit light at a subset of wavelengths including at least the channel wavelength (e.g., λⱼ) associated with the multi-channel transmitter including the broadly-tunable FP laser. The associated channel wavelength may be at the beginning of the subset of channel wavelengths, at the end of the subset of channel wavelengths, or in the middle of the subset of channel wavelengths. For example, the broadly-tunable FP laser 402-1 in the multi-channel transmitter 420-1 associated with the first channel is tuned to emit light at a subset of wavelengths (λ₁ to λ₁₊ₖ) including at least the first channel wavelength (λ₁), the broadly-tunable FP laser 402-j in the multi-channel transmitter 420-j associated with the j^{th} channel is tuned to emit light at a subset of wavelengths (λⱼ₋ₕ to λⱼ₋ₘ) including at least the j^{th} channel wavelength (λⱼ), and the broadly-tunable FP laser 402-n in the multi-channel transmitter 420-n associated with the n^{th} channel is tuned to emit light at a subset of wavelengths (λₙ₋ₖ to λₙ) including at least the n^{th} channel wavelength (λₙ). Some of the broadly-tunable FP lasers may be tuned to the same subset of channel wavelengths and some of the broadly-tunable FP lasers may be tuned to different subsets of channel wavelengths.

The WDM optical system 400 further includes filters 415-1 to 415-n to select the channel wavelengths associated with each of the respective transmitters and a multiplexer 416 to combine the selected channel wavelengths. In other words, the filters 415-1 to 415-n reject the wavelengths outside of the relatively narrow range around the selected channel wavelengths associated with the respective transmitters 420-1 to 420-n. For example, the filter 415-1 selects a first channel wavelength (X₁) from the subset of channel wavelengths (λ₁ to λ₁₊ₖ) transmitted by the multi-channel transmitter 420-1 associated with the first channel, the filter 415-j selects a j^{th} channel wavelength (λⱼ) from the subset of channel wavelengths (λⱼ₋ₕ, to λⱼ₊ₘ,) transmitted by the multi-channel transmitter 420-j associated with the j^{th} channel, and so forth. In one example, each subset of wavelengths may include three channel wavelengths within 32 channel wavelengths (λ₁ to λ₃₂) of a WDM-PON system and the filters select one of those three channel wavelengths. The broadly-tunable FP lasers 402-1 to 402-n may also be capable of tuning the envelope of wavelengths across the widest possible spectrum (e.g., ideally at least 35 nm, so as to be able to cover the complete “C-band” or “L-band”). Using broadly-tunable Fabry-Perot lasers in the transmitters provides the further advantage of avoiding wasted power, for example, as compared to selecting a wavelength from a full spectrum of wavelengths.

Although FIG. 3 shows all full-spectrum FP lasers 302-1 to 302-n and FIG. 4 shows all broadly-tunable FP lasers 402-1 to 402-n, a WDM optical system may also include a combination of full-spectrum FP lasers and broadly-tunable lasers. In other words, the full-spectrum FP lasers and broadly-tunable FP lasers may be interchangeable within a WDM optical system.

As shown in FIG. 5, another embodiment of a WDM optical system 500 including multi-channel transmitters 520-1 to 520-n includes an AWG 530 that provides both the channel wavelength selection and the multiplexing. The AWG 530 includes an array of waveguides 534-1 to 534-n coupled between input ports 532-1 to 532-n and an output port 536. The AWG 530 may include existing AWGs that provide the desired channel wavelengths on the respective waveguides 534-1 to 534-n, effectively filtering the light passing through the AWG 530. When the wavelength selection is provided by an element already present in the WDM-PON network, little if any extra cost is incurred.

The output from each of the multi-channel transmitters 520-1 to 520-n is optically coupled to the respective input ports 532-1 to 532-n. The AWG 530 filters the light at different channel wavelengths for each of the input ports 532-1 to 532-n such that the light passes through each of the waveguides 534-1 to 532-n at the different channel wavelengths associated with the respective transmitters 520-1 to 520-n. The AWG 530 thereby selects the associated channel wavelengths from the multiple channel wavelengths emitted by the FP lasers 502-1 to 502-n in the multi-channel transmitters 520-1 to 520-n before combining the selected channel wavelengths on the output port 536. As discussed above, the FP lasers 502-1 to 502-n may include full-spectrum lasers emitting light across a full spectrum of system channel wavelengths (λ₁ to λₙ) and/or broadly-tunable lasers emitting light across a subset of the system channel wavelengths (e.g., λ₁ to λ₁₊ₖ or λₙ₋ₖ to λₙ).

The AWG 530 may be a dense WDM (DWDM) AWG with thirty-two (32) AWG inputs and waveguides for thirty-two (32) channels, although other AWG configurations with other numbers of channels are within the scope of the present disclosure. Although the example embodiment shows an AWG, the WDM system may also include other types of optical multiplexers capable of filtering light at different channel wavelengths associated with different respective input ports of the optical multiplexer. Also, multiple AWGs may be used to provide the channel wavelength selection.

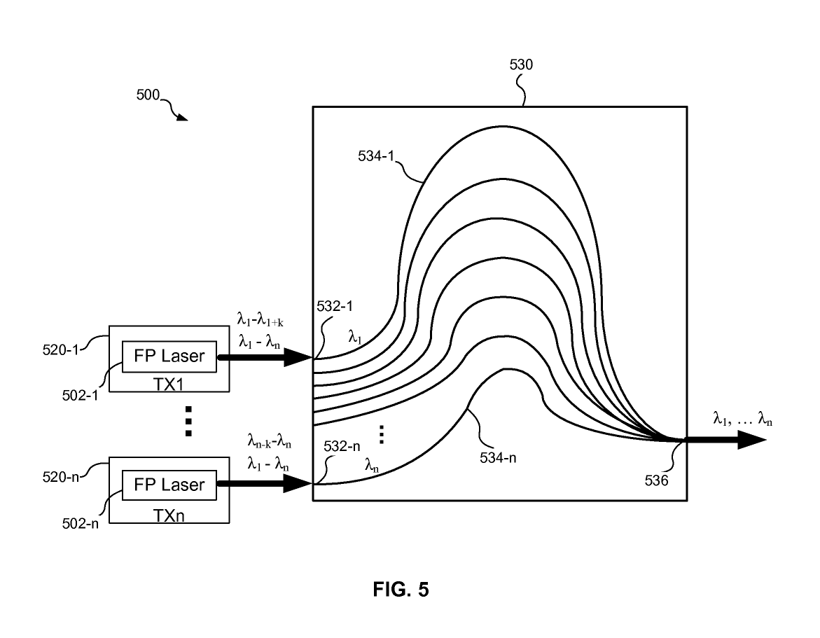

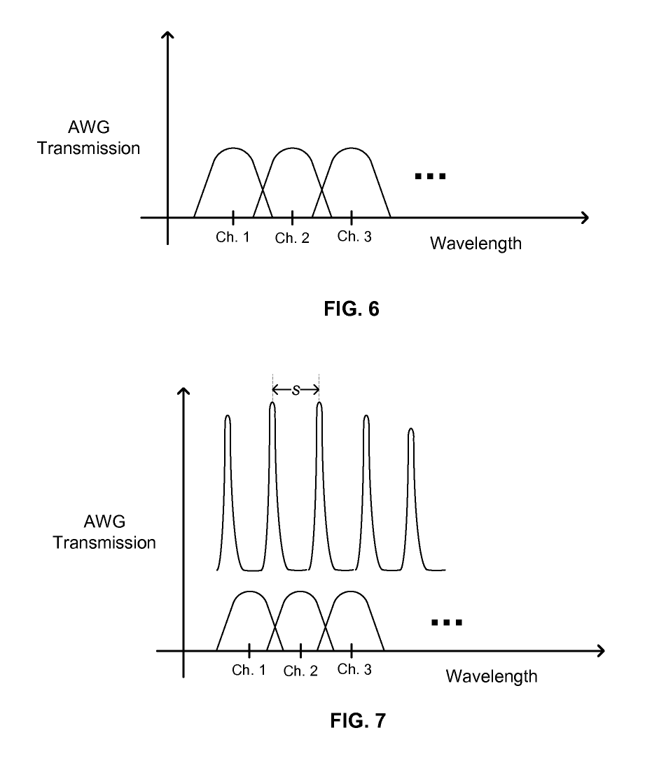

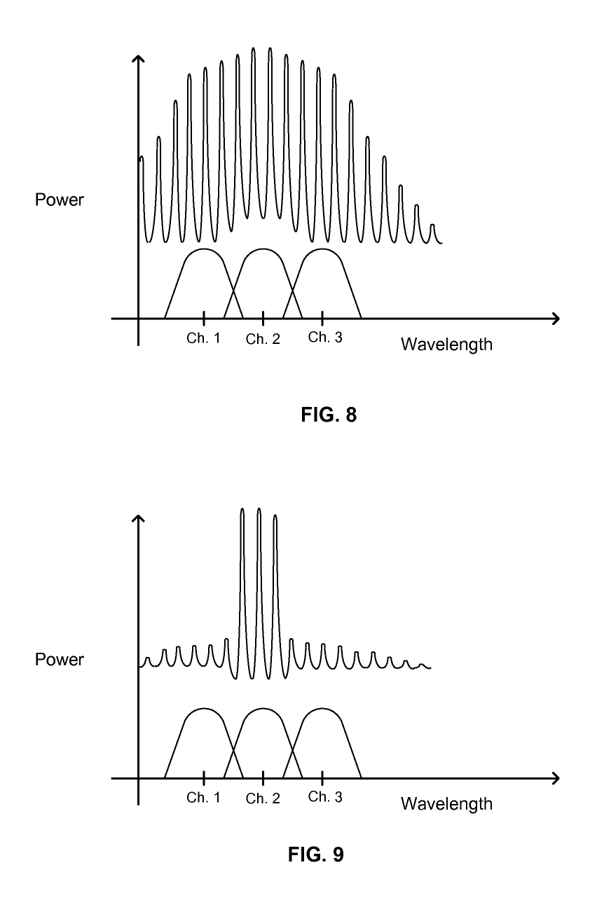

The Fabry-Perot lasers designed to be used in the WDM optical system or network described herein may also have a relatively narrow mode spacing such that multiple modes (e.g., approximately 3) will fit within each passband of the filters. As shown in FIG. 6, for example, an AWG is capable of passing a range or band of wavelengths around each of the channel wavelengths. If the mode spacing (S) in the FP laser is too wide, as shown in FIG. 7, the modes or peaks may not correspond with a desired channel wavelength to be selected. Narrowing the mode spacing of the FP laser, as shown in FIG. 8, ensures that at least one of the modes or peaks will pass within each of the channel wavelength bands after the AWG. As shown in FIG. 9, for example, three modes pass through the channel wavelength band for the second channel. One example of a FP laser with narrow mode spacing is disclosed in greater detail in U.S. Provisional Patent Application Ser. No. 61/508,014 (Attorney Docket No. PAT146P) and in U.S. patent application Ser. No. ______ (Attorney Docket No. PAT146US) filed concurrently herewith, both of which are incorporated herein by reference.

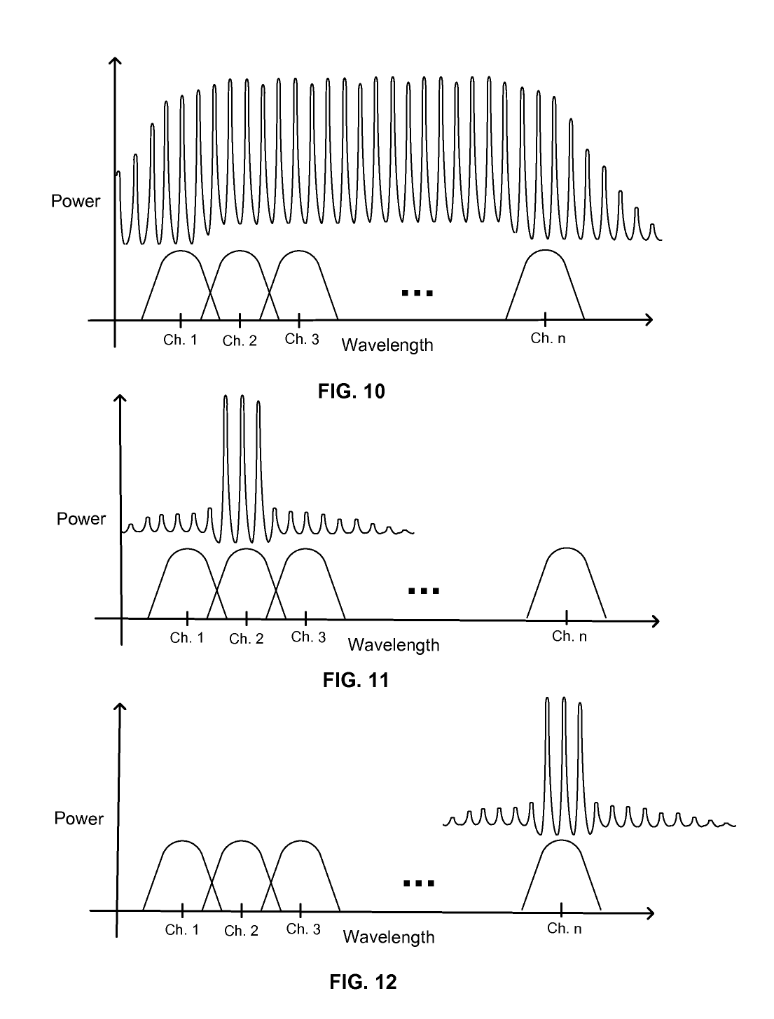

FIGS. 10-12 illustrate the laser spectrum and channel wavelength selection when a full-spectrum FP laser is used. As shown in FIG. 10, a full-spectrum FP laser may emit a full spectrum of wavelengths covering at least the system channel wavelengths (e.g., λ₁ to λₙ) used by a WDM system. The wavelength(s) within a selected channel band may then be selected by an AWG, as shown in FIGS. 11 and 12, for the respective transmitters. FIG. 11 shows the selection of a channel wavelength for the transmitter associated with channel 2 and FIG. 12 shows the selection of a channel wavelength for the transmitter associated with channel n.

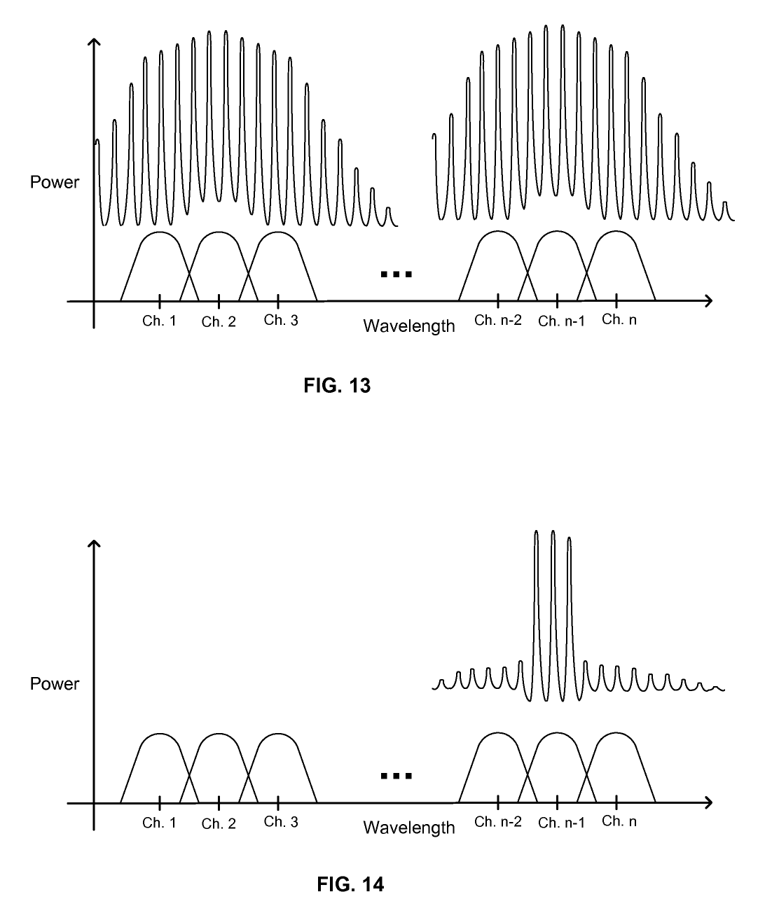

FIGS. 13-14 illustrate the laser spectrum and channel wavelength selection when a broadly-tunable FP laser is used. As shown in FIG. 13, a broadly-tunable FP laser may be tuned (e.g., by increasing the temperature) to shift the spectrum of the laser from one subset of wavelengths (e.g., λ₁, λ₂, λ₃) to another subset of wavelengths (e.g., λₙ₋₂, λₙ₋₁, λₙ) covering at least the channel wavelength (λₙ₋₁) that will be selected by the AWG, as shown in FIG. 14, for that laser/transmitter.

Accordingly, a WDM optical system with multi-channel transmitters, consistent with embodiments described herein, allows a universal transmitter to be used at multiple different locations and/or for multiple different channels without requiring more expensive, finely tunable lasers.

Consistent with one embodiment, a wavelength division multiplexed (WDM) optical system transmits optical signals at a plurality of system channel wavelengths and includes a plurality of multi-channel transmitters. Each of the multi-channel transmitters is associated with an associated channel and channel wavelength and is configured to transmit optical signals at multiple channel wavelengths including the associated channel wavelength. Each of the multi-channel transmitters includes a Fabry-Perot laser for emitting light across a range of wavelengths including the multiple channel wavelengths such that each of the multi-channel transmitters is configured to output an optical signal across the range of wavelengths including the multiple channel wavelengths. The WDM optical system also includes a plurality of filters for receiving optical signals output from the multi-channel transmitters, respectively. Each of the filters is configured to filter an optical signal from a respective one of the multi-channel transmitters such that the associated channel wavelength for the respective one of the multi-channel transmitters is selected from the multiple channel wavelengths transmitted by the respective one of the multi-channel transmitters. The WDM system further includes an optical multiplexer configured to combine the selected associated channel wavelengths for the respective transmitters into a multiplexed optical signal.

Consistent with another embodiment, a WDM optical system transmits optical signals at a plurality of system channel wavelengths and includes a plurality of broadly-tunable Fabry-Perot lasers. Each of the broadly-tunable Fabry-Perot lasers is associated with an associated channel and channel wavelength and is configured to be tuned to emit light across different ranges of wavelengths including subsets of the plurality of system channel wavelengths such that an optical signal is output from each of the broadly-tunable Fabry-Perot lasers on a subset of the plurality of system channel wavelengths. The WDM optical system further includes an arrayed waveguide grating (AWG) including a plurality of input ports coupled to the broadly-tunable Fabry-Perot lasers, respectively, and an output port. The AWG is configured to filter light received on each of the input ports at different respective channel wavelengths for each of the input ports such that the associated channel wavelength is selected from the subset of the plurality of system channel wavelengths output by each of the broadly-tunable Fabry-Perot lasers. The AWG is also configured to provide the filtered light to the output port such that the selected associated channel wavelengths are combined into a multiplexed optical signal.

Consistent with a further embodiment, a wavelength division multiplexed (WDM) optical system transmits optical signals at a plurality of system channel wavelengths and includes a plurality of full-spectrum Fabry-Perot lasers. Each of the full-spectrum Fabry-Perot lasers is associated with an associated channel and channel wavelength and is configured to emit light across a range of wavelengths including the plurality of system channel wavelengths such that an optical signal is output from each of the full-spectrum Fabry-Perot lasers on all of the plurality of system channel wavelengths. The WDM optical system further includes an arrayed waveguide grating (AWG) including a plurality of input ports coupled to the full-spectrum Fabry-Perot lasers, respectively, and an output port. The AWG is configured to filter light received on each of the input ports at different respective channel wavelengths for each of the input ports such that the associated channel wavelength is selected from the plurality of system channel wavelengths output by each of the full-spectrum Fabry-Perot lasers. The AWG is also configured to provide the filtered light to the output port such that the selected associated channel wavelengths are combined into a multiplexed optical signal.

Consistent with yet another embodiment, an optical transmission method includes: transmitting a plurality of optical signals from respective multi-channel transmitters, each of the plurality of optical signals being transmitted at multiple channel wavelengths; selecting a different channel wavelength for each of the multi-channel transmitters from the plurality of channel wavelengths transmitted by each of the multi-channel transmitters; and combining the selected channel wavelengths into an aggregate wavelength division multiplexed optical signal carried on an optical path.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A wavelength division multiplexed (WDM) optical system for transmitting optical signals at a plurality of system channel wavelengths, the WDM optical system comprising:
a plurality of multi-channel transmitters, each of the multi-channel transmitters being associated with an associated channel and channel wavelength and configured to transmit optical signals at multiple channel wavelengths including the associated channel wavelength, each of the multi-channel transmitters including a Fabry-Perot laser for emitting light across a range of wavelengths including the multiple channel wavelengths such that each of the multi-channel transmitters is configured to output an optical signal across the range of wavelengths including the multiple channel wavelengths;
a plurality of filters for receiving optical signals output from the multi-channel transmitters, respectively, each of the filters being configured to filter an optical signal from a respective one of the multi-channel transmitters such that the associated channel wavelength for the respective one of the multi-channel transmitters is selected from the multiple channel wavelengths transmitted by the respective one of the multi-channel transmitters; and
an optical multiplexer configured to combine the selected associated channel wavelengths for the respective transmitters into a multiplexed optical signal.

2. The WDM optical system of claim 1 wherein the Fabry-Perot lasers in the multi-channel transmitters include broadly-tunable Fabry-Perot lasers configured to be tuned to emit different ranges of wavelengths, wherein each of the ranges of wavelengths includes a subset of the plurality of system channel wavelengths.

3. The WDM optical system of claim 2 wherein the broadly-tunable Fabry-Perot lasers are tunable by changing a temperature to shift an emitted wavelength spectrum.

4. The WDM optical system of claim 1 wherein the Fabry-Perot lasers in the multi-channel transmitters include full-spectrum Fabry-Perot lasers configured to emit a full spectrum of wavelengths covering all of the system channel wavelengths.

5. The WDM optical system of claim 1 wherein the filters are integrated with the optical multiplexer.

6. The WDM optical system of claim 5 wherein the filters and the optical multiplexer are integrated as an arrayed waveguide grating (AWG).

7. The WDM optical system of claim 1 wherein the Fabry-Perot lasers have a mode spacing such that multiple lasing modes fit within each passband of the filters.

8. The WDM optical system of claim 1 further comprising a plurality optical networking terminals (ONTs) in a WDM passive optical network (PON), wherein the plurality of multi-channel transmitters are located in the plurality of ONTs, respectively.

9. The WDM optical system of claim 1 further comprising at least one optical line terminal (OLT) in a WDM passive optical network (PON), wherein the plurality of multi-channel transmitters are located in the at least one OLT.

10. The WDM optical system of claim 1 wherein the plurality of channel wavelengths include wavelengths in the L-band.

11. The WDM optical system of claim 1 wherein the plurality of channel wavelengths include wavelengths in the C-band.

12. A wavelength division multiplexed (WDM) optical system for transmitting optical signals at a plurality of system channel wavelengths, the WDM optical system comprising:
a plurality of broadly-tunable Fabry-Perot lasers, each of the broadly-tunable Fabry-Perot lasers being associated with an associated channel and channel wavelength and being configured to be tuned to emit light across different ranges of wavelengths including subsets of the plurality of system channel wavelengths such that an optical signal is output from each of the broadly-tunable Fabry-Perot lasers on a subset of the plurality of system channel wavelengths; and
an arrayed waveguide grating (AWG) including a plurality of input ports coupled to the broadly-tunable Fabry-Perot lasers, respectively, and an output port, wherein the AWG is configured to filter light received on each of the input ports at different respective channel wavelengths for each of the input ports such that the associated channel wavelength is selected from the subset of the plurality of system channel wavelengths output by each of the broadly-tunable Fabry-Perot lasers, and wherein the AWG is configured to provide the filtered light to the output port such that the selected associated channel wavelengths are combined into a multiplexed optical signal.

13. The WDM optical system of claim 12 further comprising a plurality optical networking terminals (ONTs) in a WDM passive optical network (PON), wherein the plurality of broadly-tunable Fabry-Perot lasers are located in the plurality of ONTs, respectively.

14. The WDM optical system of claim 12 further comprising at least one optical line terminal (OLT) in a WDM passive optical network (PON), wherein the plurality of broadly-tunable Fabry-Perot lasers are located in the at least one OLT.

15. The WDM optical system of claim 12 wherein the plurality of system channel wavelengths include wavelengths in the L-band.

16. The WDM optical system of claim 12 wherein the plurality of system channel wavelengths include wavelengths in the C-band.

17. A wavelength division multiplexed (WDM) optical system for transmitting optical signals at a plurality of system channel wavelengths, the WDM optical system comprising:
a plurality of full-spectrum Fabry-Perot lasers, each of the full-spectrum Fabry-Perot lasers being associated with an associated channel and channel wavelength and being configured to emit light across a range of wavelengths including the plurality of system channel wavelengths such that an optical signal is output from each of the full-spectrum Fabry-Perot lasers on all of the plurality of system channel wavelengths; and
an arrayed waveguide grating (AWG) including a plurality of input ports coupled to the full-spectrum Fabry-Perot lasers, respectively, and an output port, wherein the AWG is configured to filter light received on each of the input ports at different respective channel wavelengths for each of the input ports such that the associated channel wavelength is selected from the plurality of system channel wavelengths output by each of the full-spectrum Fabry-Perot lasers, and wherein the AWG is configured to provide the filtered light to the output port such that the selected associated channel wavelengths are combined into a multiplexed optical signal.

18. The WDM optical system of claim 17 further comprising a plurality optical networking terminals (ONTs) in a WDM passive optical network (PON), wherein the plurality of broadly-tunable Fabry-Perot lasers are located in the plurality of ONTs, respectively.

19. The WDM optical system of claim 17 further comprising at least one optical line terminal (OLT) in a WDM passive optical network (PON), wherein the plurality of broadly-tunable Fabry-Perot lasers are located in the at least one OLT.

20. The WDM optical system of claim 17 wherein the plurality of system channel wavelengths include wavelengths in the L-band.

21. The WDM optical system of claim 17 wherein the plurality of system channel wavelengths include wavelengths in the C-band.

22. An optical transmission method comprising:
transmitting a plurality of optical signals from respective multi-channel transmitters, each of the plurality of optical signals being transmitted at multiple channel wavelengths;
selecting a different channel wavelength for each of the multi-channel transmitters from the plurality of channel wavelengths transmitted by each of the multi-channel transmitters; and
combining the selected channel wavelengths into an aggregate wavelength division multiplexed optical signal carried on an optical path.

23. The method of claim 22 wherein the plurality of channel wavelengths include a subset of system channel wavelengths produced by tuning a Fabry-Perot laser in each of the optical transmitters.

24. The method of claim 22 wherein the plurality of channel wavelengths include a full spectrum of system channel wavelengths produced by a Fabry-Perot laser in each of the optical transmitters.
